(19) United States
(12) Patent Application Publication
(10) Pub. No.: US 2026/0027656 A1
(43) Pub. Date: Jan. 29, 2026

(54) RUST REMOVING LASER DEVICE

(71) Applicant: NTT, Inc., Tokyo (JP)

(72) Inventors: Masahiro Ueno, Tokyo (JP); Sohan Kawamura, Tokyo (JP); Takashi Sakamoto, Tokyo (JP); Masayuki Tsuda, Tokyo (JP)

(21) Appl. No.: 19/101,755

(22) PCT Filed: Aug. 9, 2022
(86) PCT No.: PCT/JP2022/030397

§ 371 Date: Feb. 6, 2025

(51) Int. Cl. B23K 26/36; B23K 26/70

(52) U.S. Cl. CPC B23K 26/36; B23K 26/702

(57) ABSTRACT

A rust removing laser device includes a laser that outputs a first laser beam for rust removal, a LiDAR device that outputs a second laser beam for distance measurement and calculates a distance to an object on the basis of return beam, a laser emission head that irradiates an object with the first and second laser beams and returns reflection beam of the second laser beam from the object to the LiDAR device, and a controller that outputs the first laser beam from the laser when a distance to the object is included in a predetermined distance range, and stops the output of the first laser beam when the distance to the object is not included in the distance range.

### CROSS-REFERENCE TO RELATED APPLICATIONS

This application is a national phase entry of PCT Application No. PCT/JP2022/030397, filed on Aug. 9, 2022, which application is hereby incorporated herein by reference.

### TECHNICAL FIELD

The present invention relates to a rust removing laser device having a safety function for preventing a person or an object other than a rust removal object from being damaged by high power laser irradiation.

### BACKGROUND

There is a problem of rust removal in a confined place which is difficult to reach by a hand or an electric power tool in rust removal work which is indispensable for a long service life of a communication infrastructure facility such as a steel tower for supporting a communication service. Therefore, a technique for improving the efficiency of the rust removal work by using a high-power laser device has been studied (refer to NPL 1). When such a laser device is used, there is a possibility that the laser beam will hit a person or an object other than the rust removal object.

In the related art, there is a technique disclosed in NPL 2 as a technique for preventing destruction of a device using a laser. A mechanism for preventing the optical gain medium from being destroyed is disclosed in NPL 2. Specifically, according to the technique disclosed in NPL 2, an amplified spontaneous emission (ASE) beam is observed, and a pump beam source is turned off before an optical gain of an optical gain medium becomes a gain which causes parasitic laser oscillation or Q switching.

However, the technique disclosed in NPL 2 is for protecting the optical gain medium, and a safety function for preventing a high-power laser beam from hitting a person or an object other than the rust removal object has not been conventionally realized in the rust removing laser device disclosed in NPL 1.

### CITATION LIST

### Non Patent Literature

[NPL 1] “Toward realization of rust removal technique using high power laser device”, NTT Technology Journal, pp. 56 to 58, April 2021 <https://journal.ntt.co.jp/wp-content/uploads/2021/12/JN4_all.pdf>
[NPL 2] P. Booker, O. De Varona, M. Steinke, P. Wessels, J. Neumann, and D. Kracht, “Experimental and numerical study of interlock requirements for high-power EYDFAs”, Optics Express, Vol. 28, No. 21, pp. 31480-31486, 2020

### SUMMARY

### Technical Problem

An object of examples of the present invention is to provide a rust removing laser device capable of reducing the likelihood that a laser beam for rust removal will be radiated to an object or a person other than a rust removal object.

### Solution to Problem

A rust removing laser device of examples of the present invention includes a laser unit configured to output a first laser beam for rust removal; a LiDAR unit configured to output a second laser beam for distance measurement and calculate a distance to the object on the basis of return beam from an object; a laser emission head configured to irradiate the object with the first and second laser beams so that a principal ray of the first laser beam coincides with a principal ray of the second laser beam, and to return a reflection beam of the second laser beam from the object to the LiDAR unit; and a control unit configured to output the first laser beam from the laser unit when a distance to the object is included in a predetermined distance range, and to stop the output of the first laser beam when the distance is not included in the distance range.

### Advantageous Effects

According to examples of the present invention, since the first laser beam is output from the laser unit only when an object is present on a principal ray of the first laser beam and a distance to the object is included in a predetermined distance range, if a range in which an rust removal object is assumed to exist is set as a predetermined distance range, it is possible to reduce the possibility that an object or a person other than the rust removal object is irradiated with the laser beam, and safety can be enhanced. Further, since the irradiation of the first laser beam to the outside of the predetermined distance range can be prevented, the installation of a curing curtain for preventing unnecessary irradiation of the laser beam becomes unnecessary, and the labor of rust removal work can be reduced.

### BRIEF DESCRIPTION OF THE DRAWINGS

FIG. 1 is a block diagram showing a configuration of a rust removing laser device according to a first example of the present invention.

FIG. 2 is a block diagram showing a specific example of the rust removing laser device according to the first example of the present invention.

FIG. 3 is a block diagram showing a configuration of a target interferometer according to the first example of the present invention.

FIG. 4 is a block diagram showing a configuration of a reference interferometer according to the first example of the present invention.

FIG. 5 is a diagram showing an example of a relationship between a phase change curve and a resampling time.

FIG. 6 is a block diagram showing a configuration of a control signal processing unit according to the first example of the present invention.

FIG. 7 is a block diagram showing another configuration of the control signal processing unit according to the first example of the present invention.

FIG. 8 is a block diagram showing a configuration of a rust removing laser device according to a second example of the present invention.

FIG. 9 is a block diagram showing another configuration of the rust removing laser device according to the second example of the present invention.

FIG. 10 is a block diagram showing a configuration of a laser emission head according to a third example of the present invention.

FIG. 11 is a block diagram showing an example of a configuration of a computer that implements the signal processing device and control signal processing unit according to the first to third examples of the present invention.

### DETAILED DESCRIPTION OF ILLUSTRATIVE EXAMPLES

### First Example

Examples of the present invention will be described hereinafter with reference to the drawings. In the present invention, only when an object exists on the principal ray of the rust removing laser beam and a distance from a rust removing laser emission head to the object is within a range set by the user, is the rust removing laser beam irradiated.

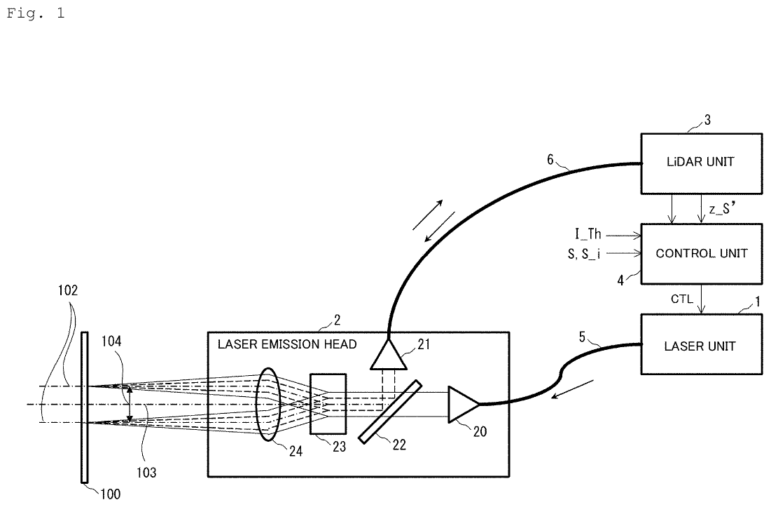

FIG. 1 is a block diagram showing a configuration of a rust removing laser device according to a first example of the present invention. The rust removing laser device includes a laser unit 1, a laser emission head 2, a light detection and ranging (LiDAR) unit 3, and a control unit 4.

The configuration and operation of each unit will be described below. The laser emission head 2 simultaneously emits respective beams, by making the principal ray of the laser beam for rust removal made incident from the laser unit 1 via an optical fiber 5 and the principal ray of the laser beam for LiDAR made incident from the LiDAR unit 3 via an optical fiber 6 coincide with each other.

The laser emission head 2 includes a fiber collimator (FC) 20 which converts a laser beam for rust removal made incident from the laser unit 1 via the optical fiber 5 into a parallel beam, an FC 21 which converts the laser beam for LiDAR made incident from the LiDAR unit 3 via the optical fiber 6 into parallel beam and making the reflection beam of a dichroic mirror 22 incident on the optical fiber 6, a dichroic mirror 22 which transmits a beam from the FC 20, reflects a beam from the FC 21, and reflects a beam from the object 100 and returns it to the FC 21, an optical deflector 23 which deflects the beam from the dichroic mirror 22, and a condensing optical system 24 which condenses the beam from the optical deflector 23 to irradiate the object 100 with a beam, and converts the reflection beam from the object 100 into a parallel beam and makes it incident on the optical deflector 23.

When the wavelength of the laser beam for rust removal is made different from that of the laser beam for LiDAR, it is possible to use the dichroic mirror 22 which transmits the laser beam for rust removal and reflects the laser beam for LiDAR. The wavelength of the laser beam for rust removal is, for example, 1,070 nm, and the wavelength of the laser beam for LiDAR is, for example, 1,310 nm or 1,550 nm.

The beam emitted from the FCs 20 and 21 is multiplexed by the dichroic mirror 22, and radiated on the object 100 through the optical deflector 23 and the condensing optical system 24. At this time, optical axes of the FCs 20 and 21 are adjusted so that the principal ray of the laser beam for rust removal coincides with the principal ray of the laser beam for LiDAR. Reference numeral 102 of FIG. 1 denotes principal rays of the laser beam for rust removal and the laser beam for LiDAR, which are irradiated to the object 100. Reference numeral 103 denotes an optical axis of the condensing optical system 24, and reference numeral 104 denotes a width capable of scanning the object 100 by optical deflection by the optical deflector 23.

As an example of the arrangement of the optical deflector 23 and the condensing optical system 24, it is conceivable to dispose them to form a telecentric system. A telecentric system is an optical system in which all principal rays of beam emitted from the condensing optical system 24 are parallel to each other regardless of the angle of optical deflection by the optical deflector 23. Specifically, for example, the telecentric system is disposed so that the distance between a deflection origin of the optical deflector 23 and an incident side principal point of the condensing optical system 24 becomes a focal length of the condensing optical system 24.

By irradiating the object 100 with the laser beam for rust removal, rust of the object 100 can be removed. Further, by changing the deflection angle of the optical deflector 23, the laser beam can scan the object 100.

The reflection beam from the object 100 is converted into parallel beam by the condensing optical system 24, and enters the dichroic mirror 22 through the optical deflector 23. The dichroic mirror 22 reflects beam in a specific wavelength region (laser beam for LiDAR in present example). The FC 21 makes the reflection beam of the dichroic mirror 22 incident on the optical fiber 6.

The LiDAR unit 3 takes in the laser beam for the LiDAR returned from the surface of the object 100 via the laser emission head 2 and the optical fiber 6, and calculates the distance to the object 100 by using the beam. As the LiDAR method, for example, a time of flight (TOF) method or a frequency modulated continuous wave (FMCW) method can be used.

The control unit 4 controls the laser unit 1 by the control signal CTL, and turns on/off the output of the laser beam for rust removal from the laser unit 1. The control unit 4 outputs the laser beam from the laser unit 1 when all of the plurality of conditions are satisfied, and stops the output of the laser beam when at least one condition is not satisfied.

As conditions for the control unit 4 to determine the establishment or non-establishment, there are at least two conditions. A first condition is a condition that the object 100 exists within a distance range set by the user. A second condition is that the intensity of the return beam received from the laser emission head 2 by the LiDAR unit 3 exceeds the intensity set by the user. The second condition is a condition assuming that the object 100 is not on the principal ray of the laser beam for the LiDAR.

First, the first condition will be described. When a distance range set by the user is S, a user designates two of a minimum value dmin and a maximum value dmax (dmin<dmax) of the distance. S is in a range of dmin or more and dmax or less.

When J (J is an integer of 2 or more) distance ranges S_i (i is an integer of o to J-1) are set, the user designates two of a minimum value d_i_min and a maximum value d_i_max (d_i_min<d_i_max) of the distance for each range. S_i is in a range of d_i_min or more and d_i_max or less.

The control unit 4 compares the set distance range S with a distance z_S′ calculated by the LiDAR unit 3, and determines that the first condition is satisfied when the distance z_S′ is included in the distance range S (dmin≤+z_S′≤+dmax). The control unit 4 determines that the first condition is satisfied, when a plurality of distance ranges S_i are set and the distance z_S′ is included in any of the plurality of distance ranges S_i (d_i_min≤z_S′≤d_i_max).

Next, the second condition will be described. An intensity threshold set by the user is defined as I_Th. The control unit 4 compares the set intensity threshold value I_Th with the intensity I of the return beam received by the LiDAR unit 3, and determines that the second condition is satisfied when the intensity I exceeds the threshold value I_Th (I>I_Th). When the second condition is satisfied, it can be determined that the object 100 exists on the principal ray of the laser beam for the LiDAR emitted from the laser emission head 2.

The control unit 4 causes the laser unit 1 to output the laser beam for rust removal when both the first and second conditions are satisfied, and stops the output of the laser beam when at least one of the first condition and the second condition is not satisfied.

The laser unit 1 includes a laser beam source for rust removal. The laser beam source has a structure capable of turning on/off a laser output by a control signal CTL that is output from the control unit 4. When there is an interlock terminal in the laser beam source, the on/off of the laser output may be controlled by inputting the control signal CTL from the control unit 4 to this terminal.

However, some of the laser beam sources require a time of several seconds to obtain the output beam when the laser output is turned on/off by the interlock terminal, or some of the laser beam sources require ON manipulation of a physical switch when the laser output is turned on again after the laser output is turned off. With such a laser beam source, on/off of the laser output cannot be realized in a short time.

Therefore, it is also possible to realize the on/off control of the laser output by using a laser beam source capable of modulating the intensity of the output laser beam by an input signal from the outside, and by supplying a control signal CTL as a signal for driving the laser beam source from the control unit 4 to modulate the intensity of the laser beam. Alternatively, on/off control of the laser output may be realized, by using a laser beam source having an external modulator, and by supplying the control signal CTL from the control unit 4 as a signal for driving the external modulator to perform intensity modulation of the laser beam.

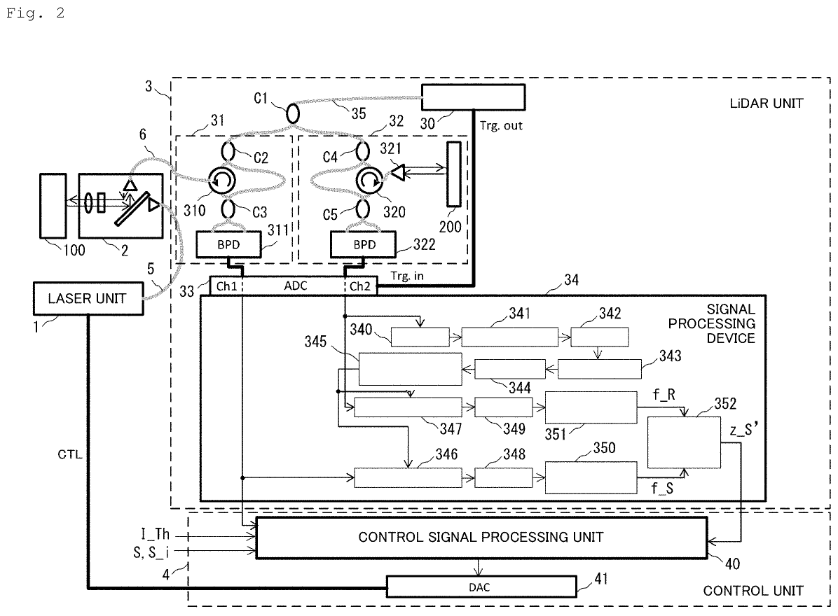

FIG. 2 is a block diagram showing a specific example of the rust removing laser device shown in FIG. 1. In this example, an FMCW type configuration is used as the configuration of the LiDAR unit 3. The advantage of using the FMCW type configuration as the LiDAR unit 3 is that the beam generated from the removal object heated by the rust removing laser and taken into the LiDAR unit 3 does not substantially affect the distance measurement. The reason for this is that the beam generated by the heat generation does not substantially interfere with the laser beam generated in the LiDAR unit 3. The LiDAR unit 3 includes a wavelength sweeping beam source 30, a coupler C1, a target interferometer 31 (first interferometer), a reference interferometer 32 (second interferometer), an AD converter (ADC) 33, and a signal processing device 34. Reference numeral 35 of FIG. 2 denotes an optical fiber for connecting the wavelength sweeping beam source 30 and the coupler C1.

The wavelength sweeping beam source 30 outputs continuous beam obtained by temporally sweeping the wavelength. The beam output from the wavelength sweeping beam source 30 is divided by a coupler C1, and one beam is made incident on the target interferometer 31 and the other beam is made incident on the reference interferometer 32.

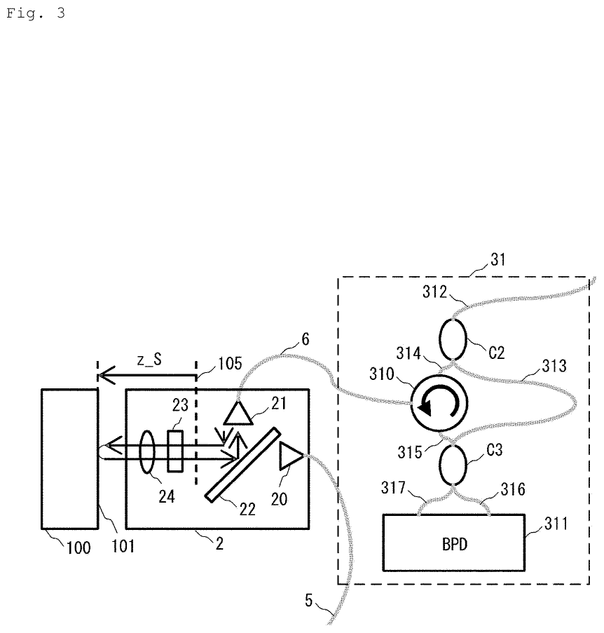

A configuration of the target interferometer 31 is shown in FIG. 3. The target interferometer 31 includes couplers C2 and C3, a circulator 310, a balanced photodetector (BPD) 311, an optical fiber 312 which connects the coupler C1 and the coupler C2, an optical fiber 313 which connects the coupler C2 and the coupler C3, an optical fiber 314 which connects the coupler C2 and the circulator 310, an optical fiber 315 which connects the circulator 310 and the coupler C3, and optical fibers 316 and 317 which connect the coupler C3 and the BPD 311.

Although the configuration of the target interferometer 31 is shown in FIGS. 2 and 3 for matching with the configuration of FIG. 1, since the target interferometer forms a pair with the reference interferometer 32, the laser emission head 2 and the object 100 are also included in the configuration of the target interferometer.

The coupler C2 divides the beam from the coupler C1 into two. The circulator 310 outputs the beam from the optical fiber 314 to the optical fiber 6 and outputs the beam from the optical fiber 6 to the optical fiber 315. The configuration and operation of the laser emission head 2 are as described above, and the laser beam for LiDAR from the wavelength sweeping beam source 30 and the laser beam for rust removal from the laser unit 1 are irradiated to the object 100.

In present example, among the optical paths between the couplers C2 and C3, an optical path (an optical path not including a reflective surface 101 of the object 100) passing through the optical fiber 313 is defined as a. Among the optical paths between the coupler C2 and the coupler C3, an optical path, which follows paths of optical fiber 314→circulator 310→optical fiber 6→FC 21→dichroic mirror 22→optical deflector 23→condensing optical system 24→reflective surface 101 of object 100→condensing optical system 24→optical deflector 23→dichroic mirror 22→FC 21→optical fiber 6→circulator 310→optical fiber 315, is defined as b.

The reference surface 105 of the target interferometer 31 is a virtual surface, and has the same optical path length as the optical path a when beam is reflected on this surface. In FIG. 3, since the distance from the reference surface 105 of the target interferometer 31 to the reflective surface 101 of the object 100 is z_S, an optical path length difference between two optical paths a and b between the coupler C2 and the coupler C3 is 2z_S.

A coupler C3 multiplexes the beam from the optical fiber 313 and the beam from the optical fiber 315. The BPD 311 photoelectrically converts the two outputs from the coupler C3, obtains a difference between the two analogue electric signals obtained as a result of the photoelectric conversion, and outputs the difference.

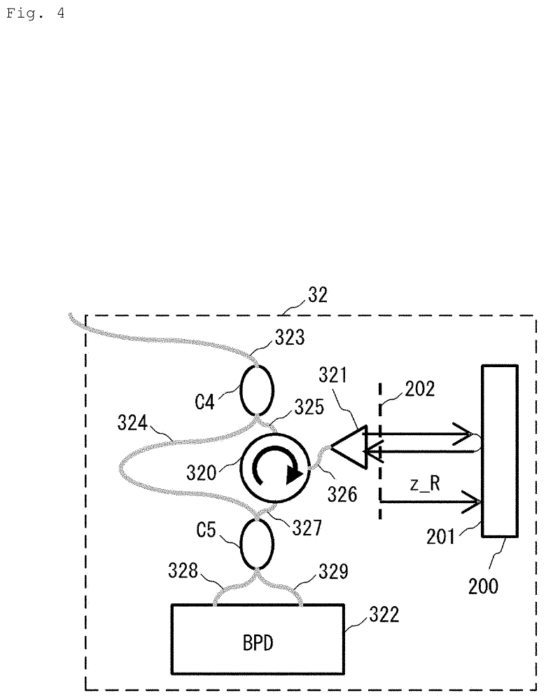

A configuration of the reference interferometer 32 is shown in FIG. 4. The reference interferometer 32 includes couplers C4 and C5, a circulator 320, an FC 321, a BPD 322, an optical fiber 323 which connects the coupler Ci and the coupler C4, an optical fiber 324 which connects the coupler C4 and the coupler C5, an optical fiber 325 which connects the coupler C4 and the circulator 320, an optical fiber 326 which connects the circulator 320 and the FC 321, an optical fiber 327 which connects the circulator 320 and the coupler C5, and optical fibers 328 and 329 which connect the coupler C5 and the BPD 322.

The coupler C4 divides the beam from the coupler C1 into two. The circulator 320 emits beam from the optical fiber 325 to the optical fiber 326, and emits beam from the optical fiber 326 to the optical fiber 327. The FC 321 converts the beam from the optical fiber 326 into parallel beam, irradiates the mirror 200 with the parallel beam, and makes the reflection beam from the mirror 200 incident on the optical fiber 326.

Among the optical paths between the coupler C4 and the coupler C5, the optical path passing through the optical fiber 324 is defined as c. Further, among optical paths between the coupler C4 and the coupler C5, an optical path, which follows the paths of optical fiber 325→circulator 320→optical fiber 326→FC 321→reflective surface 201 of mirror 200→FC 321→optical fiber 326→circulator 320→optical fiber 327, is set as d

The reference interferometer 32 is obtained by replacing the object 100 of the target interferometer 31 with the mirror 200. The reference surface 202 is a virtual surface, and has the same optical path length as that of the optical path c when beam is reflected on the virtual surface. A distance from the reference surface 202 to the reflective surface 201 of the mirror 200 is known z_R. Therefore, the optical path length difference between the two optical paths c and d between the couplers C4 and C5 becomes 2z_R.

The coupler C5 multiplexes the beam from the optical fiber 324 and the beam from the optical fiber 327. The BPD 322 photoelectrically converts two outputs from the coupler C5, respectively, obtains a difference between two analogue electric signals obtained as a result of the photoelectric conversion and outputs the difference.

The ADC 33 performs AD conversion on an electric signal input from the BPD 311 of the target interferometer 31 to a first channel and an electric signal input from the BPD 322 of the reference interferometer 32 to a second channel, respectively. In present example, a signal obtained from the target interferometer 31 through the first channel of the ADC 33 is defined as a target interference signal, and a signal obtained from the reference interferometer 32 through the second channel of the ADC 33 is defined as a reference interference signal.

The signal processing device 34 processes the digital signal output from the ADC 33. The signal processing device 34 includes a Fourier transform unit 340, a negative frequency component zero unit 341, an inverse Fourier transform unit 342, a deflection angle calculation unit 343, a phase connection unit 344, a resampling time calculation unit 345, resampling units 346 and 347, Fourier transform units 348 and 349, intensity peak frequency detection units 350 and 351, and a distance calculation unit 352.

The Fourier transform unit 340 outputs a signal obtained by Fourier-transforming the reference interference signal obtained from the reference interferometer 32 through the ADC 33.

The negative frequency component zero unit 341 performs processing for making the negative frequency component of the output signal of the Fourier transform unit 340 zero, and outputs a signal of the processing result thereof.

The inverse Fourier transform unit 342 outputs a signal obtained by performing inverse Fourier transform on the output signal of the negative frequency component zero unit 341.

The deflection angle calculation unit 343 calculates a deflection angle of each time of the complex signal output from the inverse Fourier transform unit 342. The range of deflection angles is −π to π, or o to 2π.

The phase connection unit 344 performs phase connection processing for making the deflection angle into a continuous phase value, and defines the processing result as a phase change curve. When the deflection angles are arranged in the order of time t (t=o, 1, . . . , M-1, M is the number of samples of data obtained by the ADC 33), only when the absolute value of the deflection angle difference between the adjacent ones becomes π/2 or more, the phase connection unit 344 performs connection so that the deflection angle becomes a continuous phase value.

In a case where the absolute value of the difference between the deflection angle θ(t) of the time t and the deflection angle θ(t+1) of the time t+1 becomes π/2 or more, when the number of times of connecting the deflection angle till then is set as K, and the positive and negative of θ(t)−θ(t+1) are set as Sign, a deflection angle θ_u of the time t+1 after the phase connection becomes θ_u=θ(t+1)+Sign×2π×(K+1). Such a phase connection process may be referred to as an unwrapping process.

A phase change curve obtained by the phase connection unit 344 represents a temporal phase change of the reference interference signal, and monotonously increases (in the case of Sign>o) or monotonously decreases (in the case of Sign<o) with respect to time in accordance with the positive and negative Sign of the deflection angle difference. However, when a small noise is superimposed on the deflection angle before the phase connection, there is a case where the phase change curve does not increase monotonously or decrease monotonously due to the vertical movement of the noise.

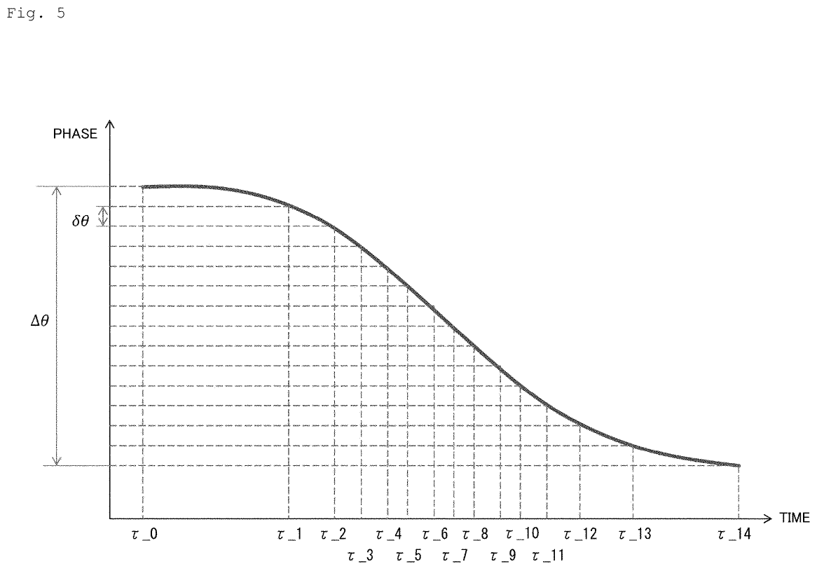

The resampling time calculation unit 345 generates a resampling time τ_n (n=o to N-1) used in resampling units 346 and 347 from the phase change curve obtained by the phase connection unit 344. FIG. 5 is a diagram showing an example of the relationship between the phase change curve and the resampling time τ_n. The resampling time τ_n is a time when the phase change curve becomes an equal phase interval δθ.

In a case where a user designates the number N of samples when the target interference signal and the reference interference signal are sampled again by the resampling units 346 and 347, the phase interval δθ can be calculated from the phase change width Δθ (maximum phase-minimum phase) of the phase change curve as in equation (1).

$$δ θ = Δ θ / ( N - 1 ) \qquad ( 1 )$$

The resampling time calculation unit 345 calculates a time at which θ(n) represented by equation (2) is obtained as the resampling time τ_n (n=o to N-1).

$${θ}^{′} ( n ) = θ ( 0 ) + n δθ \qquad ( 2 )$$

In equation (2), θ(o) represents the phase of the phase change curve at time t=o. In the case of θ_u(t)<θ′(n)<θ_u(t+1), the resampling time τ_n of θ_u(τ_n)=θ′(n) is calculated by interpolation. When a linear interpolation is used, the resampling time calculation unit 345 calculates the resampling time τ_n by equation (3).

$$τ\_n = t \vert θ\_u ( t + 1 ) - {θ}^{′} ( n ) \vert + ( t + 1 ) \vert {θ}^{′} ( n ) - θ\_u ( t ) \vert \qquad ( 3 )$$

In equation (3), |x| represents an absolute value of x. The resampling unit 346 samples a target interference signal obtained from the target interferometer 31 through the ADC 33 synchronously with the resampling time τ_n, and outputs an interference signal after resampling processing.

The resampling unit 347 samples a reference interference signal obtained from the reference interferometer 32 through the ADC 33 synchronously with the resampling time τ_n, and outputs an interference signal after resampling processing. Note that τ_n is generally a real number. When τ_n is a real number, resampling is performed by interpolation such as linear interpolation.

By the resampling, the phase of the target interference signal and the reference interference signal linearly changes with respect to the time τ_n. Since the mirror 200 is provided in the reference interferometer 32, the reflection point is one point, and thus, the reference interference signal after resampling becomes a sine wave. If the principal ray of the laser beam for the LiDAR emitted from the laser emission head 2 crosses the surface of the object 100 and the reflection beam from the object 100 contributes to interference in the target interferometer 31 as return beam, the reflection point is one point, and therefore the target interference signal after resampling becomes a sine wave.

The Fourier transform unit 348 outputs a signal obtained by Fourier-transforming the target interference signal that is output from the resampling unit 346. The Fourier transform unit 349 outputs a signal obtained by Fourier-transforming the reference interference signal that is output from the resampling unit 347. As described above, when the interference signal is a sine wave, the signal after the Fourier transform is calculated as a spectrum having a peak. The signal having this peak is called a point spread function (PSF). The frequency of the peak position of the PSF obtained from the target interference signal indicates the position of the reflective surface 101 of the object 100. The frequency of the peak position of the PSF obtained from the reference interference signal indicates the position of the reflective surface 201 of the mirror 200.

The intensity peak frequency detection unit 350 detects a frequency f_S of the peak position of the PSF obtained by the Fourier transform unit 348. The intensity peak frequency detection unit 351 detects a frequency f_R of the peak position of the PSF obtained by the Fourier transform unit 349.

The distance calculation unit 352 calculates an estimated value z_S′ of a distance z_S from the reference surface 105 of the target interferometer 31 to the reflective surface 101 of the object 100 by equation (4), on the basis of the distance z_R, the frequency f_S detected by the intensity peak frequency detection unit 350, and the frequency f_R calculated by the intensity peak frequency detection unit 351.

$${z\_S}^{′} = z\_R \times f\_S / f\_R \qquad ( 4 )$$

The distance z_R is a value of ½ of the optical path length difference between two optical paths between the coupler C4 and the coupler C5 inside the reference interferometer 32. Usually, although the rust removal is performed in the atmosphere, in this case, z_R is a value converted into air. When the rust is removed in a medium other than air such as water, the value is converted on the basis of the beam velocity of the medium.

Next, as shown in FIG. 2, the control unit 4 includes a control signal processing unit 40 and a DA converter (DAC) 41.

The control signal processing unit 40 outputs a digital signal for turning on/off the laser light that is output from the laser unit 1, on the basis of the intensity threshold value I_Th set by the user, the distance range S or S_i set by the user, the intensity I of the return beam received by the LiDAR unit 3, and the distance z_S′ calculated by the LiDAR unit 3. The DAC 41 performs the DA conversion of the digital signal that is output from the control signal processing unit 40, and outputs an analogue control signal CTL to the laser unit 1.

When the user sets one distance range S, the control signal processing unit 40 outputs a digital signal for causing the laser unit 1 to output a laser beam for rust removal, when the distance z_S′ to the object 100 is included in the distance range S and the intensity I of the return beam received by the LiDAR unit 3 exceeds a threshold value I_Th. The control signal processing unit 40 outputs a digital signal for stopping the laser beam, when at least one of a case where the distance z_S′ is not included in the distance range S and a case where the intensity I of the return beam is equal to or less than the threshold value I_Th occurs.

When a user sets a plurality of distance ranges S_i, if the distance z_S′ to the object 100 is included in any of the distance ranges S_i and the intensity I of the return beam received by the LiDAR unit 3 exceeds the threshold value I_Th, the control signal processing unit 40 outputs a digital signal for outputting the laser beam for rust removal from the laser unit 1. The control signal processing unit 40 outputs a digital signal for stopping the laser beam, when at least one of a case where the distance z_S′ is not included in any of the distance ranges S_i and a case where the intensity I of the return beam is equal to or less than the threshold value I_Th occurs.

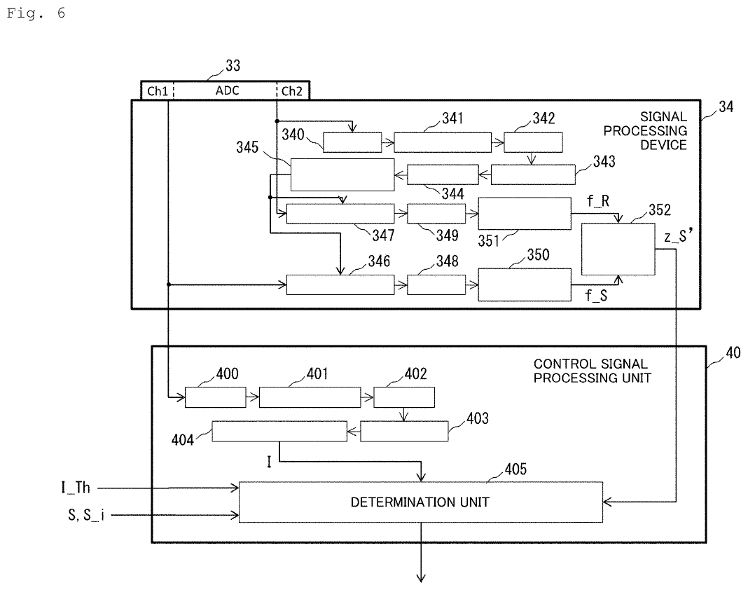

Next, a method of acquiring the intensity I of the return beam received by the LiDAR unit 3 will be described. FIG. 6 shows the configuration of the control signal processing unit 40 for obtaining the intensity I of the return beam. FIG. 6 shows an example of obtaining the intensity I of the return beam from the target interference signal by calculation.

The control signal processing unit 40 includes a Fourier transform unit 400, a negative frequency component zero unit 401, an inverse Fourier transform unit 402, an intensity calculation unit 403, a time average calculation unit 404 and a determination unit 405.

The Fourier transform unit 400 outputs a target interference signal for a sweep time of the wavelength sweeping beam source 30 or a signal obtained by Fourier-transforming the target interference signal for a half time of the sweep time, among the target interference signals obtained from the target interferometer 31 through the ADC 33.

The negative frequency component zero unit 401 performs processing for making the negative frequency component of the output signal of the Fourier transform unit 400 zero, and outputs a signal of the processing result thereof.

The inverse Fourier transform unit 402 outputs a signal obtained by performing inverse Fourier transform on the output signal of the negative frequency component zero unit 401.

The intensity calculation unit 403 calculates a value obtained by multiplying the sum of the square of the real part and the square of the imaginary part by 4, as the intensity of the complex signal that is output from the inverse Fourier transform unit 402 at each time

The time average calculation unit 404 calculates a time average value of the intensity calculated by the intensity calculation unit 403 as the intensity I of the return beam received by the LiDAR unit 3. Since the trigger of the ADC 33 is synchronized with the sweep frequency of the wavelength sweeping beam source 30, the time average is executed for each sweep period of the wavelength sweeping beam source 30.

The determination unit 405 outputs a digital signal for outputting a laser beam for rust removal from the laser unit 1, when the distance z_S′ to the object 100 is included in the distance ranges S, S_i and the intensity I of the return beam received by the LiDAR unit 3 exceeds the threshold value I_Th. The determination unit 405 outputs a digital signal for stopping the laser beam, when at least one of a case where the distance z_S′ is not included in the distance ranges S, S_i and a case where the intensity I of the return beam is equal to or less than the threshold value I_Th occurs.

The DAC 41 performs DA conversion of the digital signal that is output from the determination unit 405, and outputs an analogue control signal CTL to the laser unit 1.

A time waveform obtained by taking the square root of the sum of the square of the real part and the square of the imaginary part of the complex signal processed in the order of the Fourier transform unit 400, the negative frequency component zero unit 401 and the inverse Fourier transform unit 402 represents a half of the amplitude waveform (envelope waveform) of the target interference signal. This amplitude waveform is proportional to the electric field intensity of the return beam received by the LiDAR unit 3. Therefore, when the complex signal is squared and multiplied by four, a time waveform of energy can be obtained. The intensity I of the return beam can be obtained by averaging the time waveforms of the energy.

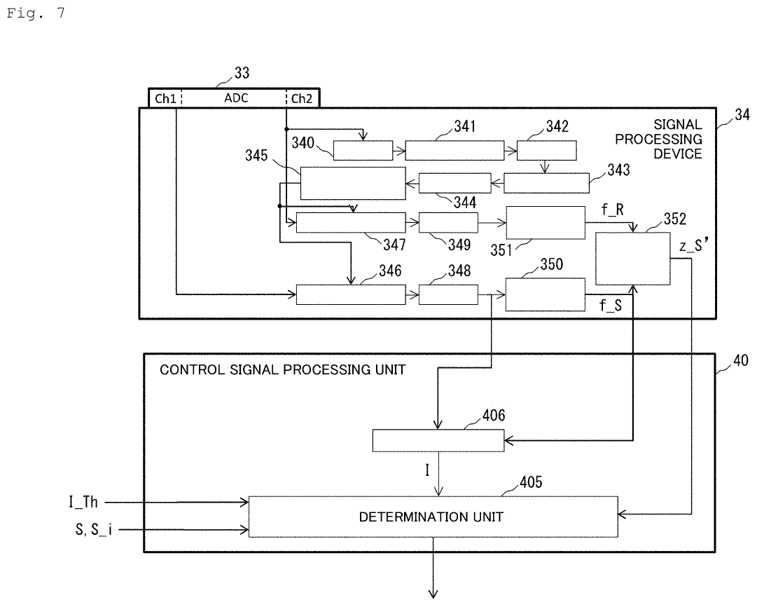

FIG. 7 shows another configuration of the control signal processing unit 40 for determining the intensity I of the return beam. The example of FIG. 7 shows an example of obtaining the intensity I of the return beam by calculation, on the basis of the result of Fourier transformation of the target interference signal after the resampling process in the LiDAR unit 3 and the peak frequency f_S obtained from the result of Fourier transformation.

The control signal processing unit 40 of the example of FIG. 7 includes a peak intensity calculation unit 406 and a determination unit 405.

In the LiDAR unit 3, a signal obtained by Fourier-transforming the target interference signal after the resampling processing by the Fourier transform unit 348 is a PSF having a peak at a frequency corresponding to a distance to the reflective surface 101 of the object 100. The peak intensity of the PSF is proportional to the electric field intensity (square root of power) of the reflection beam from the object 100.

The peak intensity calculation unit 406 acquires information on the frequency f_S at which the intensity of the PSF obtained by the Fourier transform unit 348 becomes a peak from the intensity peak frequency detection unit 350, detects the intensity of the PSF obtained by the Fourier transform unit 348 at the frequency f_S, and calculates the value obtained by squaring the detected intensity as the intensity I of the return light received by the LiDAR unit 3. The operation of the determination unit 405 is as follows.

As described above, in the present example, since the laser beam for rust removal is output from the laser unit 1 only when an object exists on the principal ray of the laser beam for rust removal and the distance z_S′ to the object is included in a predetermined distance range, if a range in which the rust removal object is assumed to exist is set as a predetermined distance range, it is possible to reduce the possibility that the object or a person other than the rust removal object is irradiated with the laser beam, and safety can be improved. Further, since the irradiation of the laser beam for rust removal to the outside of the predetermined distance range can be prevented, the installation of a curing curtain for preventing the irradiation of the unnecessary laser beam becomes unnecessary, and the labor of rust removal work can be reduced. For example, in the case where there is no safety function as in the present example, there is a possibility that the laser beam is irradiated far from the steel tower through the gap between the steel towers to be rust-removed. However, according to the present example, it is possible to prevent the laser beam from passing through.

Although laser beam for LiDAR is always output from the wavelength sweeping beam source 30, the power of the laser beam is very small as compared with the laser beam for rust removal. Therefore, even if the laser beam for the LiDAR hits an object or a person other than the rust removal object, no problem occurs.

In the present example, the control unit 4 outputs the laser beam for rust removal from the laser unit 1 when both the first and second conditions are satisfied, but the determination may be made only by the first condition. In this case, the control unit 4 may output the laser beam for rust removal from the laser unit 1 when the first condition is satisfied, and may stop the output of the laser beam when the first condition is not satisfied.

### Second Example

A second example of the present invention will be described next. In the first example, the intensity I of the return beam received by the LiDAR unit 3 was calculated from the target interference signal. In present example, an example in which a part of the return beam from the laser emission head in the target interferometer is detected by a photodetector, the detection result of the photodetector is taken into the control unit, and the intensity I of the return beam is calculated will be described.

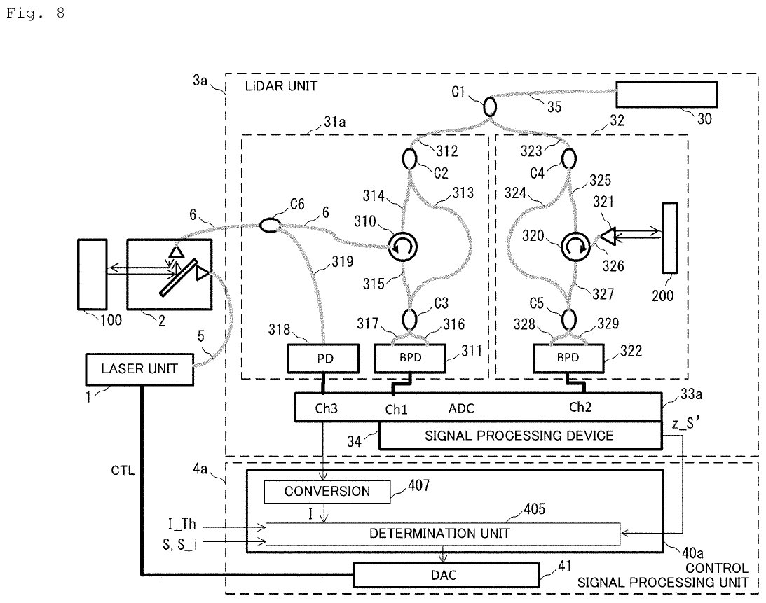

FIG. 8 is a block diagram showing the configuration of the rust removing laser device according to the present example. The rust removing laser device of the present example is provided with a laser unit 1, a laser emission head 2, a LiDAR unit 3a, and a control unit 4a. The LiDAR unit 3a includes a wavelength sweeping beam source 30, a coupler C1, a target interferometer 31a, a reference interferometer 32, an ADC 33a and a signal processing device 34.

The target interferometer 31a includes couplers C2, C3, and C6, a circulator 310, a BPD 311, optical fibers 312 to 317, a photodetector (PD) 318, and an optical fiber 319 for connecting the PD 318 and the coupler C6. The configuration of the reference interferometer 32 is the same as in the first example.

In present example, a coupler C6 is inserted in the middle of an optical fiber 6 that connects the laser emission head 2 and the circulator 310. The coupler C6 divides the return beam from the laser emission head 2 into two. One beam is incident on the circulator 310 via the optical fiber 6 in the same manner as in the first example. The other beam is made incident on the PD 318 via the optical fiber 319. The PD 318 converts the incident beam into an electrical signal.

An ADC 33a performs an AD conversion on the electric signal input from the BPD 311 of the target interferometer 31a to the first channel, the electric signal input from the BPD 322 of the reference interferometer 32 to the second channel, and the electric signal input from the PD 318 of the target interferometer 31a to the third channel, respectively. The configuration and operation of the signal processing device 34 are as described in the first example.

The control unit 4a includes a control signal processing unit 40a and a DAC 41. The control signal processing unit 40a includes a conversion unit 407 and a determination unit 405. An output signal of the PD 318 is converted into a digital signal by the ADC 33a and input to the conversion unit 407. The conversion unit 407 calculates the intensity I of the return beam received from the laser emission head 2 by the LiDAR unit 3 on the basis of the output signal of the PD 318. When a branch ratio of the coupler C6 is measured in advance, the intensity I of the return beam output from the coupler C6 to the circulator 310 can be calculated from the intensity of the output signal of the PD 318.

The operations of the determination unit 405 and the DAC 41 are as described in the first example. In this way, in this example, the same effects as those of the first example can be obtained.

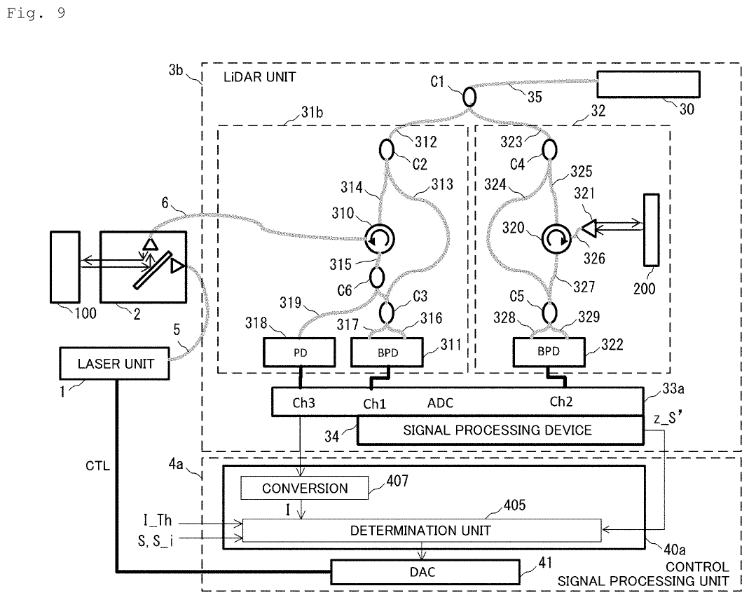

In the example of FIG. 8, the coupler C6 is inserted in the middle of the optical fiber 6, but another configurations of the present example are shown in FIG. 9. The rust removing laser device of the example of FIG. 9 is provided with a laser unit 1, a laser emission head 2, a LiDAR unit 3b, and a control unit 4a.

The LiDAR unit 3b includes a wavelength sweeping beam source 30, a coupler C1, a target interferometer 31b, a reference interferometer 32, an ADC 33a and a signal processing device 34.

The target interferometer 31b includes couplers C2, C3 and C6, a circulator 310, a BPD 311, optical fibers 312 to 317 and 319, and a PD 318. A difference from the target interferometer 31a is that the coupler C6 is inserted in the middle of an optical fiber 315 for connecting the circulator 310 and the coupler C3.

Similarly to the example of FIG. 8, the conversion unit 407 of the control signal processing unit 40a calculates the intensity I of the return beam received from the laser emission head 2 by the LiDAR unit 3 on the basis of on the output signal of the PD 318. When the branch ratio of the coupler C6 is measured in advance, the intensity I of the return beam output from the coupler C6 to the coupler C3 can be calculated from the intensity of the output signal of the PD 318.

### Third Example

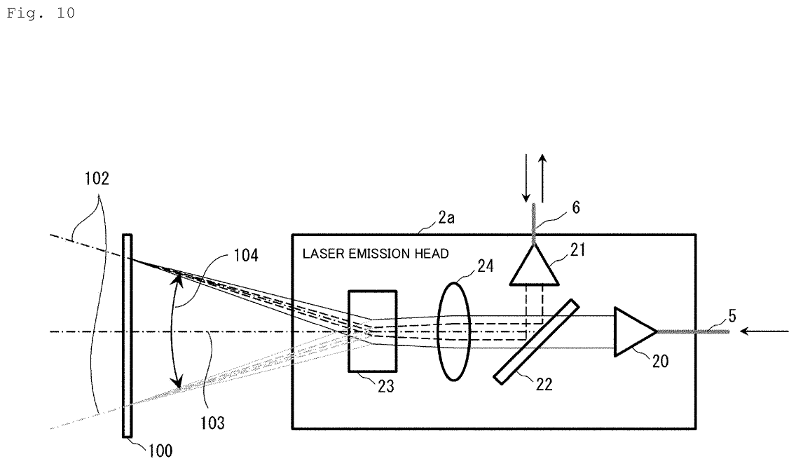

Next, a third example of the present invention will be described. FIG. 10 is a block diagram showing the configuration of the laser emission head according to the present example. In the laser emission head 2a, the positions of the optical deflector 23 and the condensing optical system 24 are reversed with respect to the laser emission head 2 of the first and second examples. Reference numeral 102 of FIG. 4 represents the optical axes of the laser beam for rust removal and the laser beam for LiDAR, which are irradiated to the object 100. Reference numeral 103 denotes an optical axis of the condensing optical system 24, and reference numeral 104 denotes a width that can be scanned on the object 100 by optical deflection by the optical deflector 23.

As described above, in the present example, by disposing the optical deflector 23 on the object 100 side, it is possible to increase the width that can be scanned on the object 100.

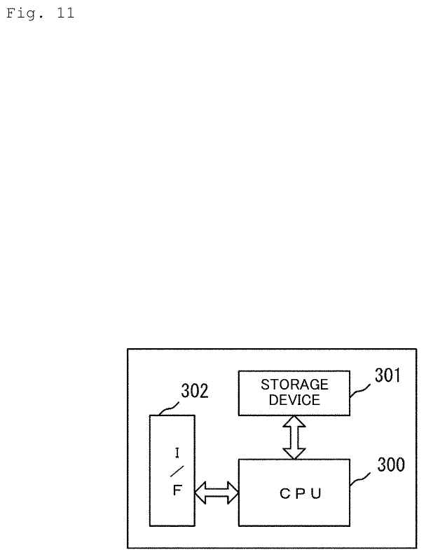

The signal processing device 34 and the control signal processing units 40 and 40a described in the first to third examples can be realized by a computer including a central processing unit (CPU), a storage device, and an interface, and a program for controlling these hardware resources. FIG. 11 shows a configuration example of the computer.

The computer includes a CPU 300, a storage device 301, and an interface device (I/F) 302. ADCs 33 and 33a, a DAC 41 or the like are connected to the I/F 302. A program for realizing the conference evaluation method of examples of the present invention is stored in the storage device 301. The CPU 300 performs processing described in the first to third examples based on the program stored in the storage device 301. Further, at least a part of the signal processing device 34 and the control signal processing units 40 and 40a may be constituted by hardware logic such as a field-programmable gate array (FPGA).

Some or all of the examples are also described in the following supplements, but are not limited to the following.

(Appendix 1) A rust removing laser device according to examples of the present invention includes: a laser unit configured to output a first laser beam for rust removal; a LiDAR unit configured to output a second laser beam for distance measurement and calculate a distance to the object on the basis of return beam from an object; a laser emission head configured to irradiate the object with the first and second laser beams so that a principal ray of the first laser beam coincides with a principal ray of the second laser beam, and to return a reflection beam of the second laser beam from the object to the LiDAR unit; and a control unit configured to output the first laser beam from the laser unit when a distance to the object is included in a predetermined distance range, and to stop the output of the first laser beam when the distance is not included in the distance range.

(Appendix 2) In the rust removing laser device set forth in Appendix 1, the control unit outputs the first laser beam from the laser unit when the distance to the object is included in the distance range and an intensity of return beam received by the LiDAR unit exceeds a predetermined threshold value, and stops the output of the first laser beam when at least one of a case where the distance is not included in the distance range and a case where the intensity of the return beam is equal to or less than the threshold value occurs.

(Appendix 3) In the rust removing laser device set forth in Appendix 1, the LiDAR unit includes a first interferometer configured to output continuous beam, which is output from a beam source and is obtained by sweeping a wavelength in time, to the laser emission head as the second laser beam, and to convert a first interference beam, which is obtained by causing beam output from the beam source to interfere with the return beam, into an electric signal to output a first interference signal; a second interferometer configured to convert a second interference beam obtained by causing beam output from the beam source to interfere with beam having a predetermined optical path length difference with respect to the beam output from the beam source into an electric signal to output a second interference signal; and a signal processing device configured to calculate a distance to the object in the first interferometer, in which the signal processing device calculates a distance from the first interferometer to the object, on the basis of a frequency of a peak position of a first PSF obtained by performing Fourier transform after resampling the first interference signal in synchronization with a resampling time calculated on the basis of a phase change curve of the second interference signal, and a frequency of a peak position of a second PSF obtained by performing Fourier transform after resampling the second interference signal in synchronization with the resampling time.

(Appendix 4) In the rust removing laser device set forth in Appendix 2, the LiDAR unit includes a first interferometer configured to output continuous beam, which is output from a beam source and is obtained by sweeping a wavelength in time, to the laser emission head as the second laser beam, and to convert a first interference beam, which is obtained by causing beam output from the beam source to interfere with the return beam, into an electric signal to output a first interference signal; a second interferometer configured to convert a second interference beam obtained by causing beam output from the beam source to interfere with beam having a predetermined optical path length difference with respect to the beam output from the beam source into an electric signal to output a second interference signal; and a signal processing device configured to calculate a distance to the object in the first interferometer, in which the signal processing device calculates a distance from the first interferometer to the object, on the basis of a frequency of a peak position of a first PSF obtained by performing Fourier transform after resampling the first interference signal in synchronization with a resampling time calculated on the basis of a phase change curve of the second interference signal, and a frequency of a peak position of a second PSF obtained by performing Fourier transform after resampling the second interference signal in synchronization with the resampling time, in which the control unit includes a Fourier transform unit configured to perform Fourier transform on the first interference signal, a negative frequency component zero unit configured to perform a process of making a negative frequency component of the output signal of the Fourier transform unit zero, an inverse Fourier transform unit configured to perform inverse Fourier transform on the output signal of the negative frequency component zero unit, an intensity calculation unit configured to calculate an intensity of a complex signal output from the inverse Fourier transform unit for each time, and a time average calculation unit configured to calculate a time average value of the intensity calculated by the intensity calculation unit as the intensity of the return beam.

(Appendix 5) In the rust removing laser device set forth in Appendix 2, the LiDAR unit includes a first interferometer configured to output continuous beam, which is output from a beam source and is obtained by sweeping a wavelength in time, to the laser emission head as the second laser beam, and to convert a first interference beam, which is obtained by causing beam output from the beam source to interfere with the return beam, into an electric signal to output a first interference signal; a second interferometer configured to convert a second interference beam obtained by causing beam output from the beam source to interfere with beam having a predetermined optical path length difference with respect to the beam output from the beam source into an electric signal to output a second interference signal; and a signal processing device configured to calculate a distance to the object in the first interferometer, in which the signal processing device calculates a distance from the first interferometer to the object, on the basis of a frequency of a peak position of a first PSF obtained by performing Fourier transform after resampling the first interference signal in synchronization with a resampling time calculated on the basis of a phase change curve of the second interference signal, and a frequency of a peak position of a second PSF obtained by performing Fourier transform after resampling the second interference signal in synchronization with the resampling time, and the control unit includes a peak intensity calculation unit configured to detect intensity of the first PSF at the frequency of the peak position, and calculate a value obtained by squaring the detected intensity as the intensity of the return beam.

Appendix 6) In the rust removing laser device set forth in Appendix 2, the LiDAR unit includes a first interferometer configured to output continuous beam, which is output from a beam source and is obtained by sweeping a wavelength in time, to the laser emission head as the second laser beam, and to convert a first interference beam, which is obtained by causing beam output from the beam source to interfere with the return beam, into an electric signal to output a first interference signal; a second interferometer configured to convert a second interference beam obtained by causing beam output from the beam source to interfere with beam having a predetermined optical path length difference with respect to the beam output from the beam source into an electric signal to output a second interference signal; and a signal processing device configured to calculate a distance to the object in the first interferometer, in which the first interferometer includes a photodetector configured to convert incident beam into an electrical signal, and a coupler configured to branch a part of the return beam and make the part of the return beam incident on the photodetector, in which the signal processing device calculates a distance from the first interferometer to the object, on the basis of a frequency of a peak position of a first PSF obtained by performing Fourier transform after resampling the first interference signal in synchronization with a resampling time calculated on the basis of a phase change curve of the second interference signal, and a frequency of a peak position of a second PSF obtained by performing Fourier transform after resampling the second interference signal in synchronization with the resampling time, and the control unit includes a conversion unit configured to calculate an intensity of the return beam on the basis of an output signal of the photodetector.

(Appendix 7) In the rust removing laser device set forth in any one of Appendices 1 to 6, the laser emission head includes a first fiber collimator configured to convert the first laser beam incident from the laser unit into parallel beam; a second fiber collimator configured to convert the second laser beam incident from the LiDAR unit into parallel beam and to make return beam from the object incident on the LiDAR unit; a dichroic mirror configured to transmit beam from the first fiber collimator in a direction of the object, reflect beam from the second fiber collimator in the direction of the object, and reflect return beam from the object to make the return beam incident on the second fiber collimator; an optical deflector configured to deflect beam from the dichroic mirror toward the object; and a condensing optical system configured to irradiate the object with beam from the optical deflector, and to make reflection beam from the object incident on the dichroic mirror through the optical deflector.

(Appendix 8) In the rust removing laser device set forth in any one of Appendices 1 to 6, the laser emission head includes a first fiber collimator configured to convert the first laser beam incident from the laser unit into parallel beam; a second fiber collimator configured to convert the second laser beam incident from the LiDAR unit into parallel beam, and to make return beam from the object incident on the LiDAR unit; a dichroic mirror configured to transmit beam from the first fiber collimator in a direction of the object, reflect beam from the second fiber collimator in the direction of the object, and reflect return beam from the object to make the return beam incident on the second fiber collimator; an optical deflector configured to deflect beam from the dichroic mirror toward the object; and a condensing optical system which is provided between the dichroic mirror and the optical deflector, and is configured to make beam from the dichroic mirror incident on the optical deflector, and make the reflection light received from the object through the optical deflector incident on the dichroic mirror.

### Industrial Applicability

Examples of the present invention can be applied to a technique for measuring the relative permittivity of an object using electromagnetic waves.

### REFERENCE SIGNS LIST

1 Laser unit
2,2a Laser emission head
3, 3a, 3b LiDAR unit
4, 4a Control unit
5, 6, 35, 312 to 317, 319, 323 to 329 Optical fiber
20, 21, 321 Fiber collimators
22 Dichroic mirrors
23 Optical deflector
24 Condensing optical system
30 Wavelength sweeping beam sources
31, 31a, 31b Target interferometer
32 Reference interferometer
33, 33a AD converter
34 Signal processing device
40, 40a Control signal processing unit
41 DA converter
310, 320 Circulator
311, 322 Balanced photodetector
318 Photodetector
340, 348, 349, 400 Fourier transform unit
341, 401 Negative frequency component zero unit
342, 402 Inverse Fourier transform unit
343 deflection angle calculation unit
344 Phase connection unit
345 Resampling time calculation unit
346, 347 Resampling unit
350, 351 Intensity peak frequency detection unit
352 Distance calculation unit
403 Intensity calculation unit
404 Time average calculation unit
405 Determination unit
406 Peak intensity calculation unit
407 Conversion unit
C1 to C6 Coupler

1-8. (canceled)

9. A rust removing laser device comprising:
a laser configured to output a first laser beam for rust removal;
a LIDAR device configured to output a second laser beam for distance measurement and calculate a distance to the object on the basis of a return beam from an object;
a laser emission head configured to irradiate the object with the first and second laser beams so that a principal ray of the first laser beam coincides with a principal ray of the second laser beam, and to return a reflection beam of the second laser beam from the object to the LiDAR device; and
a controller configured to output the first laser beam from the laser when a distance to the object is included in a predetermined distance range, and to stop the output of the first laser beam when the distance is not included in the distance range.

10. The rust removing laser device according to claim 9,
wherein the controller outputs the first laser beam from the laser when the distance to the object is included in the distance range and an intensity of return beam received by the LiDAR device exceeds a predetermined threshold value, and stops the output of the first laser beam when at least one of a case where the distance is not included in the distance range and a case where the intensity of the return beam is equal to or less than the threshold value occurs.

11. The rust removing laser device according to claim 9,
wherein the LiDAR device includes
a first interferometer configured to output a continuous beam, which is output from a beam source and is obtained by sweeping a wavelength in time, to the laser emission head as the second laser beam, and to convert a first interference beam, which is obtained by causing a beam output from the beam source to interfere with the return beam, into an electrical signal to output a first interference signal;
a second interferometer configured to convert a second interference beam obtained by causing a beam output from the beam source to interfere with a beam having a predetermined optical path length difference with respect to the beam output from the beam source into an electric signal to output a second interference signal; and
a signal processing device configured to calculate a distance to the object in the first interferometer,
wherein the signal processing device calculates a distance from the first interferometer to the object, on the basis of a frequency of a peak position of a first PSF obtained by performing Fourier transform after resampling the first interference signal in synchronization with a resampling time calculated on the basis of a phase change curve of the second interference signal, and a frequency of a peak position of a second PSF obtained by performing Fourier transform after resampling the second interference signal in synchronization with the resampling time.

12. The rust removing laser device according to claim 10,
wherein the LiDAR device includes
a first interferometer configured to output continuous beam, which is output from a beam source and is obtained by sweeping a wavelength in time, to the laser emission head as the second laser beam, and to convert a first interference beam, which is obtained by causing beam output from the beam source to interfere with the return beam, into an electric signal to output a first interference signal;
a second interferometer configured to convert a second interference beam obtained by causing beam output from the beam source to interfere with beam having a predetermined optical path length difference with respect to the beam output from the beam source into an electric signal to output a second interference signal; and
a signal processing device configured to calculate a distance to the object in the first interferometer,
wherein the signal processing device calculates a distance from the first interferometer to the object, on the basis of a frequency of a peak position of a first PSF obtained by performing Fourier transform after resampling the first interference signal in synchronization with a resampling time calculated on the basis of a phase change curve of the second interference signal, and a frequency of a peak position of a second PSF obtained by performing Fourier transform after resampling the second interference signal in synchronization with the resampling time,
wherein the controller includes
a Fourier transformer device configured to perform Fourier transform on the first interference signal,
a negative frequency component zero device configured to perform a process of making a negative frequency component of the output signal of the Fourier transform device zero,
an inverse Fourier transform device configured to perform inverse Fourier transform on the output signal of the negative frequency component zero device,
an intensity calculation device configured to calculate an intensity of a complex signal output from the inverse Fourier transform device for each of times, and
a time average calculation device configured to calculate a time average value of the intensity calculated by the intensity calculation device as the intensity of the return beam.

13. The rust removing laser device according to claim 10,
wherein the LiDAR device includes
a first interferometer configured to output continuous beam, which is output from a beam source and is obtained by sweeping a wavelength in time, to the laser emission head as the second laser beam, and to convert a first interference beam, which is obtained by causing beam output from the beam source to interfere with the return beam, into an electric signal to output a first interference signal;
a second interferometer configured to convert a second interference beam obtained by causing beam output from the beam source to interfere with beam having a predetermined optical path length difference with respect to the beam output from the beam source into an electric signal to output a second interference signal; and
a signal processing device configured to calculate a distance to the object in the first interferometer,
wherein the signal processing device calculates a distance from the first interferometer to the object, on the basis of a frequency of a peak position of a first PSF obtained by performing Fourier transform after resampling the first interference signal in synchronization with a resampling time calculated on the basis of a phase change curve of the second interference signal, and a frequency of a peak position of a second PSF obtained by performing Fourier transform after resampling the second interference signal in synchronization with the resampling time, and
the controller includes a peak intensity calculation device configured to detect an intensity of the first PSF at the frequency of the peak position, and calculate a value obtained by squaring the detected intensity as the intensity of the return beam.

14. The rust removing laser device according to claim 10,
wherein the LiDAR device includes
a first interferometer configured to output continuous beam, which is output from a beam source and is obtained by sweeping a wavelength in time, to the laser emission head as the second laser beam, and to convert a first interference beam, which is obtained by causing beam output from the beam source to interfere with the return beam, into an electric signal to output a first interference signal;
a second interferometer configured to convert a second interference beam obtained by causing beam output from the beam source to interfere with beam having a predetermined optical path length difference with respect to the beam output from the beam source into an electric signal to output a second interference signal; and
a signal processing device configured to calculate a distance to the object in the first interferometer,
wherein the first interferometer includes
a photodetector configured to convert incident beam into an electrical signal, and
a coupler configured to branch a part of the return beam and make the part of the return beam incident on the photodetector,
wherein the signal processing device calculates a distance from the first interferometer to the object, on the basis of a frequency of a peak position of a first PSF obtained by performing Fourier transform after resampling the first interference signal in synchronization with a resampling time calculated on the basis of a phase change curve of the second interference signal, and a frequency of a peak position of a second PSF obtained by performing Fourier transform after resampling the second interference signal in synchronization with the resampling time, and
the controller includes a conversion device configured to calculate an intensity of the return beam on the basis of an output signal of the photodetector.

15. The rust removing laser device according to claim 9,
wherein the laser emission head includes
a first fiber collimator configured to convert the first laser beam incident from the laser into a parallel beam;
a second fiber collimator configured to convert the second laser beam incident from the LiDAR device into a parallel beam and to make the return beam from the object incident on the LiDAR device;
a dichroic mirror configured to transmit a beam from the first fiber collimator in a direction of the object, reflect a beam from the second fiber collimator in the direction of the object, and reflect the return beam from the object to make the return beam incident on the second fiber collimator;
an optical deflector configured to deflect a beam from the dichroic mirror toward the object; and
a condensing optical system configured to irradiate the object with a beam from the optical deflector, and to make the reflection beam from the object incident on the dichroic mirror through the optical deflector.

16. The rust removing laser device according to claim 9,
wherein the laser emission head includes
a first fiber collimator configured to convert the first laser beam incident from the laser into a parallel beam;
a second fiber collimator configured to convert the second laser beam incident from the LiDAR device into a parallel beam, and to make return beam from the object incident on the LiDAR device;
a dichroic mirror configured to transmit beam from the first fiber collimator in a direction of the object, reflect beam from the second fiber collimator in the direction of the object, and reflect return beam from the object to make the return beam incident on the second fiber collimator;
an optical deflector configured to deflect beam from the dichroic mirror toward the object; and
a condensing optical system which is provided between the dichroic mirror and the optical deflector, and is configured to make beam from the dichroic mirror incident on the optical deflector, and make the reflection light received from the object through the optical deflector incident on the dichroic mirror.

17. The rust removing laser device according to claim 10,
wherein the laser emission head includes
a first fiber collimator configured to convert the first laser beam incident from the laser into a parallel beam;
a second fiber collimator configured to convert the second laser beam incident from the LiDAR device into a parallel beam and to make the return beam from the object incident on the LiDAR device;
a dichroic mirror configured to transmit a beam from the first fiber collimator in a direction of the object, reflect a beam from the second fiber collimator in the direction of the object, and reflect the return beam from the object to make the return beam incident on the second fiber collimator;
an optical deflector configured to deflect a beam from the dichroic mirror toward the object; and
a condensing optical system configured to irradiate the object with a beam from the optical deflector, and to make the reflection beam from the object incident on the dichroic mirror through the optical deflector.

18. The rust removing laser device according to claim 10,
wherein the laser emission head includes
a first fiber collimator configured to convert the first laser beam incident from the laser into a parallel beam;
a second fiber collimator configured to convert the second laser beam incident from the LiDAR device into a parallel beam, and to make return beam from the object incident on the LiDAR device;
a dichroic mirror configured to transmit beam from the first fiber collimator in a direction of the object, reflect beam from the second fiber collimator in the direction of the object, and reflect return beam from the object to make the return beam incident on the second fiber collimator;
an optical deflector configured to deflect beam from the dichroic mirror toward the object; and
a condensing optical system which is provided between the dichroic mirror and the optical deflector, and is configured to make beam from the dichroic mirror incident on the optical deflector, and make the reflection light received from the object through the optical deflector incident on the dichroic mirror.

19. The rust removing laser device according to claim 11,
wherein the laser emission head includes
a first fiber collimator configured to convert the first laser beam incident from the laser into a parallel beam;
a second fiber collimator configured to convert the second laser beam incident from the LiDAR device into a parallel beam and to make the return beam from the object incident on the LiDAR device;
a dichroic mirror configured to transmit a beam from the first fiber collimator in a direction of the object, reflect a beam from the second fiber collimator in the direction of the object, and reflect the return beam from the object to make the return beam incident on the second fiber collimator;
an optical deflector configured to deflect a beam from the dichroic mirror toward the object; and
a condensing optical system configured to irradiate the object with a beam from the optical deflector, and to make the reflection beam from the object incident on the dichroic mirror through the optical deflector.

20. The rust removing laser device according to claim 11,
wherein the laser emission head includes
a first fiber collimator configured to convert the first laser beam incident from the laser into a parallel beam;
a second fiber collimator configured to convert the second laser beam incident from the LiDAR device into a parallel beam, and to make return beam from the object incident on the LiDAR device;
a dichroic mirror configured to transmit beam from the first fiber collimator in a direction of the object, reflect beam from the second fiber collimator in the direction of the object, and reflect return beam from the object to make the return beam incident on the second fiber collimator;
an optical deflector configured to deflect beam from the dichroic mirror toward the object; and
a condensing optical system which is provided between the dichroic mirror and the optical deflector, and is configured to make beam from the dichroic mirror incident on the optical deflector, and make the reflection light received from the object through the optical deflector incident on the dichroic mirror.

21. The rust removing laser device according to claim 12,
wherein the laser emission head includes
a first fiber collimator configured to convert the first laser beam incident from the laser into a parallel beam;
a second fiber collimator configured to convert the second laser beam incident from the LiDAR device into a parallel beam and to make the return beam from the object incident on the LiDAR device;
a dichroic mirror configured to transmit a beam from the first fiber collimator in a direction of the object, reflect a beam from the second fiber collimator in the direction of the object, and reflect the return beam from the object to make the return beam incident on the second fiber collimator;
an optical deflector configured to deflect a beam from the dichroic mirror toward the object; and
a condensing optical system configured to irradiate the object with a beam from the optical deflector, and to make the reflection beam from the object incident on the dichroic mirror through the optical deflector.

22. The rust removing laser device according to claim 12,
wherein the laser emission head includes
a first fiber collimator configured to convert the first laser beam incident from the laser into a parallel beam;
a second fiber collimator configured to convert the second laser beam incident from the LiDAR device into a parallel beam, and to make return beam from the object incident on the LiDAR device;
a dichroic mirror configured to transmit beam from the first fiber collimator in a direction of the object, reflect beam from the second fiber collimator in the direction of the object, and reflect return beam from the object to make the return beam incident on the second fiber collimator;
an optical deflector configured to deflect beam from the dichroic mirror toward the object; and
a condensing optical system which is provided between the dichroic mirror and the optical deflector, and is configured to make beam from the dichroic mirror incident on the optical deflector, and make the reflection light received from the object through the optical deflector incident on the dichroic mirror.

23. The rust removing laser device according to claim 13,
wherein the laser emission head includes
a first fiber collimator configured to convert the first laser beam incident from the laser into a parallel beam;
a second fiber collimator configured to convert the second laser beam incident from the LiDAR device into a parallel beam and to make the return beam from the object incident on the LiDAR device;
a dichroic mirror configured to transmit a beam from the first fiber collimator in a direction of the object, reflect a beam from the second fiber collimator in the direction of the object, and reflect the return beam from the object to make the return beam incident on the second fiber collimator;
an optical deflector configured to deflect a beam from the dichroic mirror toward the object; and
a condensing optical system configured to irradiate the object with a beam from the optical deflector, and to make the reflection beam from the object incident on the dichroic mirror through the optical deflector.

24. The rust removing laser device according to claim 13,
wherein the laser emission head includes
a first fiber collimator configured to convert the first laser beam incident from the laser into a parallel beam;
a second fiber collimator configured to convert the second laser beam incident from the LiDAR device into a parallel beam, and to make return beam from the object incident on the LiDAR device;
a dichroic mirror configured to transmit beam from the first fiber collimator in a direction of the object, reflect beam from the second fiber collimator in the direction of the object, and reflect return beam from the object to make the return beam incident on the second fiber collimator;
an optical deflector configured to deflect beam from the dichroic mirror toward the object; and
a condensing optical system which is provided between the dichroic mirror and the optical deflector, and is configured to make beam from the dichroic mirror incident on the optical deflector, and make the reflection light received from the object through the optical deflector incident on the dichroic mirror.

25. The rust removing laser device according to claim 14,
wherein the laser emission head includes
a first fiber collimator configured to convert the first laser beam incident from the laser into a parallel beam;
a second fiber collimator configured to convert the second laser beam incident from the LiDAR device into a parallel beam and to make the return beam from the object incident on the LiDAR device;
a dichroic mirror configured to transmit a beam from the first fiber collimator in a direction of the object, reflect a beam from the second fiber collimator in the direction of the object, and reflect the return beam from the object to make the return beam incident on the second fiber collimator;
an optical deflector configured to deflect a beam from the dichroic mirror toward the object; and
a condensing optical system configured to irradiate the object with a beam from the optical deflector, and to make the reflection beam from the object incident on the dichroic mirror through the optical deflector.

26. The rust removing laser device according to claim 14,
wherein the laser emission head includes
a first fiber collimator configured to convert the first laser beam incident from the laser into a parallel beam;
a second fiber collimator configured to convert the second laser beam incident from the LiDAR device into a parallel beam, and to make return beam from the object incident on the LIDAR device;
a dichroic mirror configured to transmit beam from the first fiber collimator in a direction of the object, reflect beam from the second fiber collimator in the direction of the object, and reflect return beam from the object to make the return beam incident on the second fiber collimator;
an optical deflector configured to deflect beam from the dichroic mirror toward the object; and
a condensing optical system which is provided between the dichroic mirror and the optical deflector, and is configured to make beam from the dichroic mirror incident on the optical deflector, and make the reflection light received from the object through the optical deflector incident on the dichroic mirror.
